(19) United States
(12) Patent Application Publication
(10) Pub. No.: US 2026/0089438 A1
(43) Pub. Date: Mar. 26, 2026

(54) SOUND EMITTING APPARATUS AND ELECTRONIC KEYBOARD INSTRUMENT

(71) Applicant: CASIO COMPUTER CO., LTD., Tokyo (JP)

(72) Inventor: Hiroki AKAI, Tokyo (JP)

(73) Assignee: CASIO COMPUTER CO., LTD., Tokyo (JP)

(21) Appl. No.: 19/333,917

(22) Filed: Sep. 19, 2025

(30) Foreign Application Priority Data
Sep. 20, 2024 (JP) 2024-163369

(51) Int. Cl. H04R 1/34; G10H 1/34; H04R 1/02

(52) U.S. Cl. CPC H04R 1/345; G10H 1/34; H04R 1/025; G10H 2220/221

(57) ABSTRACT

A sound emitting apparatus includes a housing, a sound emitting component provided in the housing and having a sound emitting port, a circuit board provided in the housing in a sound emitting direction of the sound emitting component, the circuit board being disposed so as to face the sound emitting port and to be spaced apart from the sound emitting port, and a control component provided on an upper side of the circuit board, and the control component is provided in such a manner that at least a part thereof overlaps with the sound emitting component along the sound emitting direction, and the housing is provided with an opening that opens in a direction substantially orthogonal to the sound emitting direction.

### CROSS-REFERENCE TO RELATED APPLICATION

This application is based upon and claims the benefit of priority under 35 USC 119 of Japanese Patent Application No. 2024-163369 filed on September 20, 2024, the entire disclosure of which, including the specification, claims, drawings and abstract, is incorporated herein by reference in its entirety.

### BACKGROUND

### TECHNICAL FIELD

The present disclosure relates to a sound emitting apparatus and an electronic keyboard instrument.

### DESCRIPTION OF THE RELATED ART

In conventional sound emitting apparatuses for electronic keyboard instruments, there has been known a sound emitting apparatus including sound holes provided to emit sounds from a sound emitting component such as a speaker to the outside of a housing of an electronic keyboard instrument. For example, Japanese Patent Laid-Open No. 2001-356772 (JP-A-2001-356772) discloses an electronic keyboard instrument including keys and a speaker provided in an interior of a housing of the electronic keyboard instrument. In this electronic keyboard instrument, the speaker is provided on a side of a back panel of the housing. A speaker cover having numerous holes as sound holes is attached to the back panel.

### SUMMARY

According to an aspect of the present disclosure, there is provided a sound emitting apparatus including a housing, a sound emitting component provided in the housing and including a sound emitting port, a circuit board provided in the housing in a sound emitting direction of the sound emitting component, the circuit board being disposed so as to face the sound emitting port and to be spaced apart from the sound emitting port, and a control component provided on an upper side of the circuit board, wherein the control component is provided in such a manner that at least a part thereof overlaps with the sound emitting component along the sound emitting direction, and wherein the housing is provided with an opening that opens in a direction substantially orthogonal to the sound emitting direction.

### BRIEF DESCRIPTION OF THE DRAWINGS

FIG. 1A is an overall perspective view of an electronic keyboard instrument according to an embodiment of the present disclosure as viewed obliquely downwards from a front left upper side;

FIG. 1B is an overall perspective view of the electronic keyboard instrument according to the embodiment as viewed obliquely upwards from a rear right lower side;

FIG. 2 is an exploded perspective view of the electronic keyboard instrument according to the embodiment with an upper case being removed;

FIG. 3A is a plan view of the electronic keyboard instrument according to the embodiment as viewed from above with the upper case and control sections being removed;

FIG. 3B is a plan view of the electronic keyboard instrument according to the embodiment as viewed from above with printed circuit boards and a keyboard being removed further from the state shown in FIG. 3A;

FIG. 4A is a perspective sectional view taken along a line IVa-IVa in FIG. 1A;

FIG. 4B is a perspective sectional view taken along a line IVb-IVb in FIG. 1A;

FIG. 5A is an enlarged sectional view of a portion E1 surrounded by a broken line in FIG. 4A;

FIG. 5B is an enlarged sectional view of a portion E2 surrounded by a broken line in FIG. 4B;

FIG. 6A is an overall perspective view of an electronic keyboard instrument according to a first modified example as viewed obliquely downwards from a rear left upper side; and

FIG. 6B is an overall perspective view of an electronic keyboard instrument according to a second modified example as viewed obliquely downwards from a rear left upper side.

### DESCRIPTION OF THE EMBODIMENT

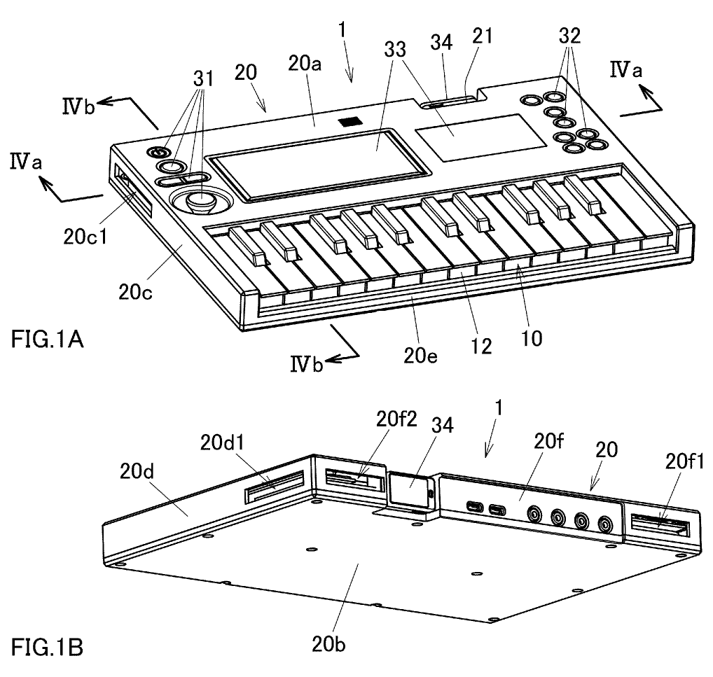

Referring to FIGS. 1A to 6B, an embodiment of the present disclosure will be described. An electronic keyboard instrument (a sound emitting apparatus) 1 shown in FIG. 1A includes a keyboard 10 having multiple keys 12 of white keys and black keys and a case (housing) 20 configured to surround and hold the keyboard 10. The electronic keyboard instrument 1 constitutes a small electronic keyboard instrument 1 having keys 12 corresponding to two octaves. In the following description, an aligning direction of the multiple keys 12 of the keyboard 10 is referred to as a left-right direction (a left side of FIG. 1A is referred to as denoting a leftward direction), an extending direction of each key 12 is referred to as a front-rear direction (a near side of FIG. 1A is referred to as denoting a forward direction), and an up-down direction of the electronic keyboard instrument 1 (a thickness direction of the case 20) is referred to as an up-down direction (an upper side of FIG. 1A is referred to as denoting an upward direction).

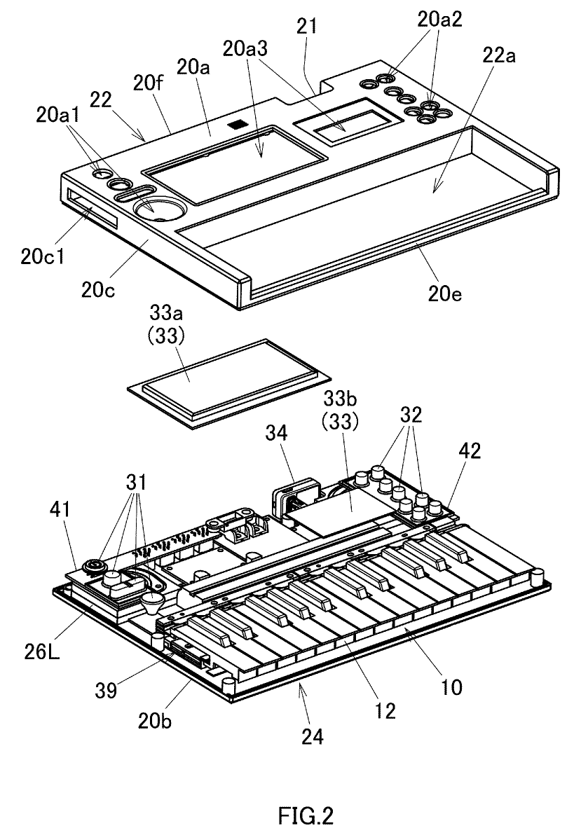

As shown in FIGS. 1A and 1B, as viewed from an upper side and a lower side thereof, the case 20 is of a substantially laterally extended rectangular shape in which a longitudinal direction follows the left-right direction. The case 20 has six surfaces (an upper surface 20a, a lower surface 20b, a left surface 20c, a right surface 20d, a front surface 20e, a rear surface 20f). In addition, as shown in FIG. 2, the case 20 includes an upper case 22 including the five surfaces (the upper surface 20a, the left surface 20c, the right surface 20d, the front surface 20e, the rear surface 20f) excluding the lower surface and a lower case 24 including the lower surface 20b. A keyboard disposing opening 22a is provided in a substantially front half area of the upper case 22 in such a manner as to open in the up-down direction, so that an upper side of the keyboard 10 is exposed when the keyboard 10 is installed in the keyboard disposing opening 22a.

As shown FIGS. 1A and 2, multiple control sections (control components) 31, 32, 33, configured to control various functions of the electronic keyboard instrument 1, are exposed in an area in the case 20 which lies on a rear side of the keyboard 10. These control sections are exposed upwards from the upper surface 20a of the case 20. Specifically speaking, a first control section 31 including, for example, a power button, a volume control button and the like of the electronic keyboard instrument 1 is exposed in a rear left end portion of the upper surface 20a. Then, a second control section 32 including, for example, a group of various effect buttons configured to apply various effects on a tone is exposed in a rear right end portion of the upper surface 20a. Further, a third control section 33 including, for example, displays 33a, 33b configured to display a played state of the electronic keyboard instrument 1 is exposed in a substantially central portion of the upper surface 20a.

Then, as shown in FIG. 2, a first opening 20a1, a second opening 20a2, and a third opening 20a3 are provided in the upper surface 20a of the case 20 in such a manner as to open correspondingly to the first control section 31, the second control section 32, and the third control section 33, respectively. In addition, a communication unit 34, configured to establish, for example, a wireless communication between the electronic keyboard instrument 1 and an external communication apparatus, is provided at a rear end portion of the case 20 in a position closer to the second control section 32. It is noted that the connection between the electronic keyboard instrument 1 and the external communication apparatus is not limited to the wireless connection. Then, a recess 21 is provided in the rear surface 20f of the case 20 in a position corresponding to the communication unit 34 in such a manner that the communication unit 34 is exposed from an outer side of the case 20. Additionally, a key press mechanism 39, configured to realize a key press interval and a tone when a player presses each key of the keyboard 10, is provided in a space defined between the keyboard 10 and the lower surface 20b.

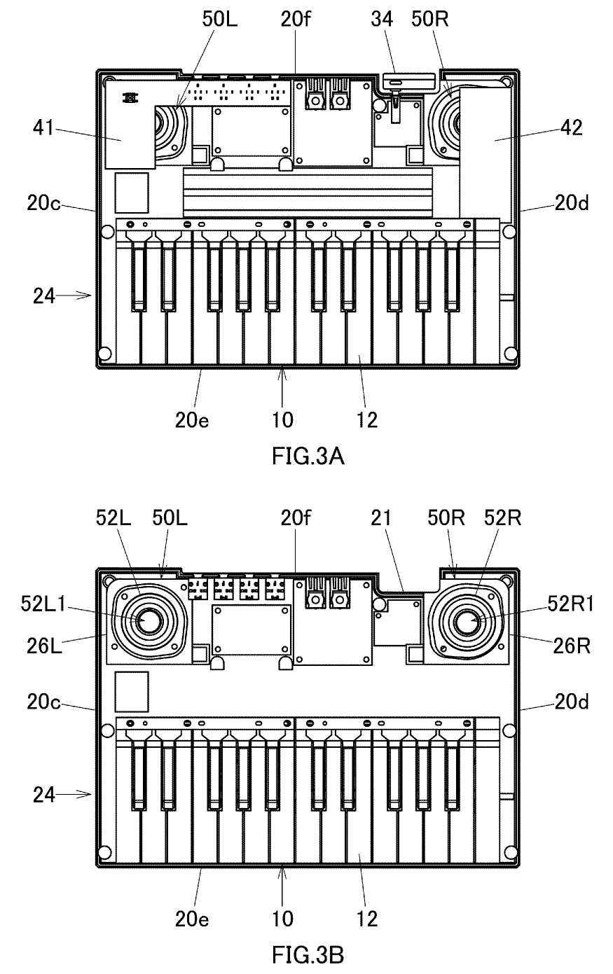

As shown in FIGS. 2 and 3A, a first circuit board (circuit board) 41, on which wiring configured to receive operations through the first control section 31 is printed, is provided on a lower side of the first control section 31. A second circuit board (circuit board) 42, on which wiring configured to receive operations through the second control section 32 is printed, is provided on a lower side of the second control section 32. In other words, the first control section 31 is placed on an upper side of the first circuit board (circuit board) 41, and the second control section 32 is placed on an upper side of the second circuit board (circuit board) 42. In addition, the first circuit board 41 is substantially of an L-shape and is disposed in the case 20 in such a manner that a corner thereof is positioned in a left rear corner of the case 20 with both planar surfaces thereof being directed in the up-down direction. The second circuit board 42 is of a rectangular shape elongated in the front-rear direction and is disposed in the case 20 in such a manner as to be positioned at a right rear end portion of the case 20 with both planar surfaces thereof being directed in the up-down direction.

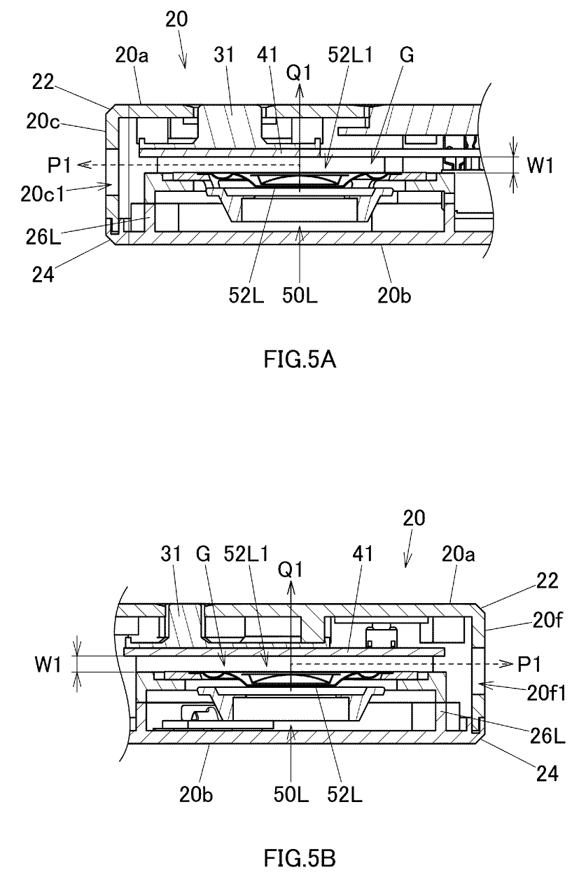

As shown in FIGS. 2 and 3B, speaker fixing sections 26L, 26R, configured to fix two speakers (sound emitting components) 50L, 50R, which will be described next, thereat respectively, are provided to the rear of the keyboard 10 in the case 20 so as to be positioned at rear left and right corners of the case 20, respectively. The speakers 50L, 50R are provided in a flat-mounted state individually at the corresponding speaker fixing sections 26L, 26R on an inner surface of the lower case 24. As a result of the speakers 50R, 50L being disposed in a flat-mounted manner, sound emitting sections 52L, 52R, each being substantially of a shape of frustum of circular cone, are sandwiched between the upper case 22 and the lower case 24 with sound emitting ports 52L1, 52R1 thereof being directed upwards. As shown in FIGS. 5A, 5B, respective sounds of the sound emitting sections 52L, 52R are emitted upwards (a sound emitting direction Q1) from the corresponding sound emitting ports 52L1, 52R1.

The speaker 50L (hereafter, also referred to as a “left speaker 50L”), which constitutes one of the speakers 50L, 50R, is provided in a left rear corner portion on the inner surface of the lower case 24. The speaker 50R (hereafter, also referred to as a “right speaker 50R”), which constitutes the other of the speakers 50L, 50R, is provided in a right rear corner portion on the inner surface of the lower case 24. In addition, the left speaker 50L is positioned on a lower side of a part of the first circuit board 41, while the right speaker 50R is positioned on a lower side of a part of the second circuit board 42. In other words, the first control section 31 and the second control section 32 are provided in such a manner that at least parts thereof overlap with respectively the first circuit board 41 and the second circuit board 42, as well as the speakers 50L, 50R along the sound emitting direction of the speakers 50L, 50R. As a result of this configuration, the keyboard 10 is provided in a position where the keyboard 10 does not overlap with the speakers 50L, 50R, as well as the first circuit board 41 and the second circuit board 42 in the sound emitting direction of the speakers 50L, 50R.

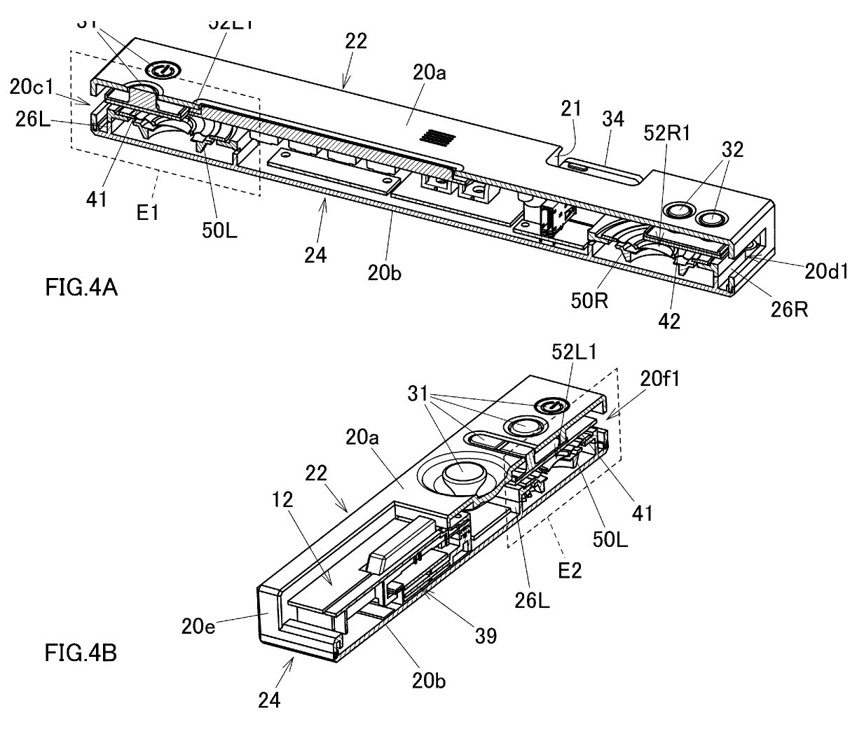

As shown in FIGS. 4A, 4B and 5A, 5B, the first circuit board 41 is provided above the left speaker 50L while being spaced apart from the sound emitting port 52L1 of the left speaker 50L. Then, the second circuit board 42 is provided above the right speaker 50R while being spaced apart from the sound emitting port 52R1 of the right speaker 50R. In other words, the first circuit board 41 is provided in such a manner as to face the sound emitting port 52L1 of the left speaker 50L in the up-down direction. Then, the second circuit board 42 is provided in such a manner as to face the sound emitting port 52R1 of the right speaker 50R in the up-down direction. A width W1 (refer to FIG. 5A) of a gap G defined between the sound emitting port 52L1 (the sound emitting port 52R1) and the first circuit board 41 (the second circuit board 42) is, for example, 2 mm. The respective upper sides (sides facing in the sound emitting direction) of the speakers 50L, 50R are covered by the first circuit board 41 and the second circuit board 42.

Substantially rectangular openings 20c1, 20f1 each elongated horizontally (hereinafter, referred to as a “left opening 20c1” and a “rear first opening 20f1”, respectively) are provided in the left surface 20c and the rear surface 20f of the upper case 22, respectively, in positions facing the left speaker 50L in the case 20 (refer to FIGS. 1A, 1B, 4A, 4B, 5A, and 5B). In addition, substantially rectangular openings 20f2, 20d1 each elongated horizontally (hereinafter, referred to as a “rear second opening 20f2” and a “right opening 20d1”, respectively) are provided in the rear surface 20f and the right surface 20d of the upper case 22, respectively, in positions facing the right speaker 50R in the case 20 (refer to FIG. 1B). The left opening 20c1 and the right opening 20d1 are formed so as to open in the left-right direction, and the rear first opening 20f1 and the rear second opening 20f2 are formed so as to open in the front-rear direction. In other words, the openings 20c1, 20d1, 20f1, 20f2 open in directions substantially orthogonal to the sound emitting direction of the speakers 50L, 50R. Here, it is noted that there is imposed no limitation to the opening shapes of the openings 20c1, 20d1, 20f1, 20f2.

In addition, as shown in FIGS. 5A and 5B, the openings 20c1, 20d1, 20f1, 20f2 are provided at a height substantially equal to the height of the gaps G defined between the respective sound emitting ports of the speakers 50L, 50R and the first and second circuit boards 41, 42 in the up-down direction. In other words, the gaps G defined between the respective sound emitting ports 52L1, 52R1 of the speakers 50L, 50R and the first and second circuit boards 41, 42 are provided in such a manner as to overlap with the openings 20c1, 20d1, 20f1, 20f2, in the directions substantially orthogonal to the sound emitting direction of the speakers 50L, 50R. No other large opening communicating with an interior and an exterior of the case 20 is provided in the case 20 than the openings 20c1,20d1, 20f1, 20f2, and the openings 20c1, 20d1, 20f1, 20f2 function as sound holes for emitting sounds emitted from the speakers 50L, 50R to the outside of the case 20.

Subsequently, a sound emitting path P for sounds emitted from the speakers 50L, 50R will be described. A sound emitted from the left speaker 50L passes through a sound emitting path P shown in FIGS. 5A and 5B to reach the outside of the case 20. That is, the sound emitted from the left speaker 50L is directed upwards from the sound emitting port 52L1 to reach the first circuit board 41 situated above the sound emitting port 52L1. The sound reaching the first circuit board 41 strikes the first circuit board 41 to thereby be bent substantially at right angles, so that the sound is effectively emitted from the left opening 20c1 and the rear first opening 20f1 to the outside (leftwards, rearwards) of the case 20. Although not shown, a sound emitting path for a sound emitted from the right speaker 50R is similar to that of the sound emitted from the left speaker 50L in that a sound is directed upwards from the sound emitting port 52R1 to reach the second circuit board 42 and is then bent substantially at right angles to be emitted effectively from the rear second opening 20f2 and the right opening 20d1 to the outside of the case 20. When referred to in the embodiment of the present disclosure, the sound emitting direction Q1 denotes a direction (an upward direction) resulting immediately after sounds are emitted from the speakers 50L, 50R. The sound emitting path P1 includes the direction of the sound which is changed as a result of the sound striking the first circuit board 41 and the second circuit board 42, that is, a direction following along a direction substantially orthogonal to the sound emitting direction Q1. When referred to in the embodiment of the present disclosure, the sound emitting direction denotes absolutely an initial sound emitting direction Q1 resulting immediately after a sound is outputted.

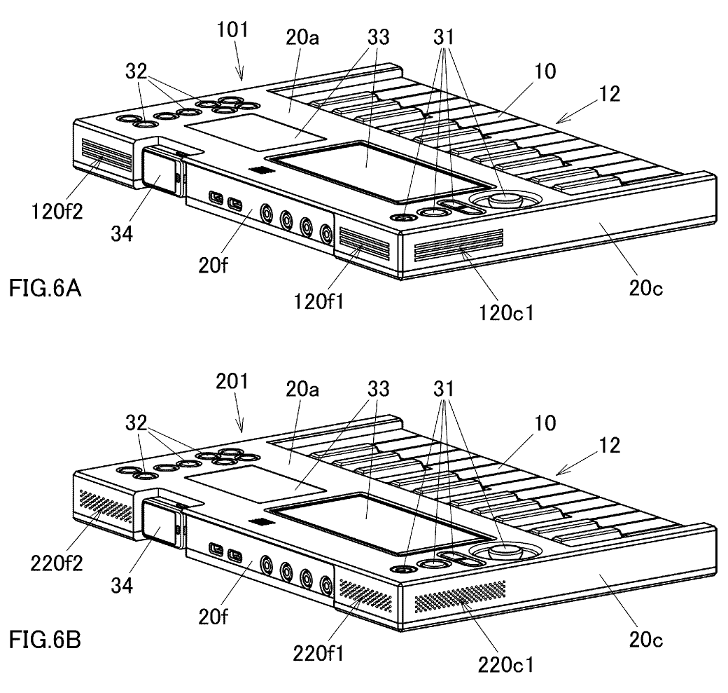

Subsequently, referring to FIGS. 6A and 6B, a first modified example and a second modified example which are made to the embodiment of the present disclosure will be described. An electronic keyboard instrument 101 according to the first modified example and an electronic keyboard instrument 201 according to the second modified example have opening shapes of the respective openings 120c1, 120f1, 120f2, 220c1, 220f1, 220f2 which are provided in a left surface 20c, a rear surface 20f, and a right surface of an upper case 22, that differ from those of the above-described embodiments. In FIGS. 6A and 6B, although a right surface of a case 20 is not shown, an opening provided in the right surface is configured similarly to the openings 120c1, 120f1, 120f2, 220c1, 220f1, 220f2 which are provided in the left surface 20c and the rear surface 20f. The other configurations and operations/working-effects of the first and second modified examples are similar to those of the embodiment that has been described heretofore, and hence, the description of the first and second modified example will be simplified or omitted by giving like reference numerals to like constituent components.

As shown in FIG. 6A, in the electronic keyboard instrument 101 according to the first modified embodiment, a left opening 120c1, a rear first opening 120f1, and a rear second opening 120f2 are each made up of multiple horizontally elongated slit-like openings. In addition, as shown in FIG. 6B, in the electronic keyboard instrument 201 according to the second modified example, a left opening 220c1, a rear first opening 220f1, and a rear second opening 220f2 are each made up of multiple small substantially circular openings. With the first modified example and the second modified example, by adopting the configurations described above, respective opening areas of the openings 120c1, 120f1, 120f2, 220c1, 220f1, 220f2 are reduced more than with the configuration of the embodiment described above, thereby making it possible to maintain the sound emitting effect while maintaining the strength of the case 20.

Here, the electronic keyboard instrument according to the embodiment of the present disclosure will be compared with the afore-said electronic keyboard instrument according to JP-A-2001-356772. With the electronic keyboard instrument disclosed in JP-A-2001-356772, the speaker is provided in the tilted state in the interior of the housing so that a sound is emitted towards the back side of the housing. This increases the size of the housing on the back side, resulting in the difficulty in reducing the size of the housing. On the other hand, when the speaker is provided in a flat-mounted configuration in the interior of the housing to reduce the size of the housing, the upper surface of the housing overlaps with the sound emitting direction of the speaker, and hence, the control component such as the volume control button configured to be operated to execute the function of the sound emitting apparatus cannot be provided freely in the upper surface of the housing.

The electronic keyboard instrument of the embodiment includes the following configurations in order to solve the problem inherent in the afore-said conventional electronic keyboard instrument. That is, the electronic keyboard instruments 1, 101, 201 include the case 20, the speakers 50L, 50R provided in the case 20 and including the sound emitting ports 52L1, 52R1, respectively, the first control section 31 and the second control section 32 which are provided in the upper surface 20a of the case 20, and the first circuit board 41 and the second circuit board 42 which are provided in the case 20 in the sound emitting direction of the speakers 50L, 50R, first circuit board 41 and the second circuit board 42 being disposed so as to face the sound emitting ports 52L1, 52R1, and to be spaced apart from the sound emitting ports 52L1, 52R1 respectively. Then, the first control section 31 and the second control section 32 are provided in such a manner that at least the parts thereof overlap with the speakers 50L, 50R, respectively, along the sound emitting direction. Further, the left opening 20c1, the rear first opening 20f1, the rear second opening 20f2, and the right opening 20d1 which are open in the direction substantially orthogonal to the sound emitting direction are provided in the case 20.

With the electronic keyboard instrument 1 of the embodiment which is configured as has been described heretofore, sounds emitted from the speakers 50L, 50R are emitted to the outside of the case 20 through the left opening 20c1, the rear first opening 20f1, the rear second opening 20f2, and the right opening 20d1 which open in the direction substantially orthogonal to the sound emitting direction. As a result, even in the case that the speakers 50L, 50R are placed in a flat-mounted manner in the case 20, the circuit boards such as the first circuit board 41 and the second circuit board 42 can be disposed in the sound emitting direction of the speakers 50L, 50R, and the first control section 31 and the second control section 32, which are configured to be controlled by the corresponding circuit boards, can be disposed in the outer surface of the case 20 in the positions situated in the sound emitting direction of the speakers 50L, 50R. In this way, with the electronic keyboard instrument 1 of the embodiment, the first control section 31 and the second control section 32 can be disposed in the sound emitting direction of the speakers 50L, 50R while realizing a reduction in size of the case 20. As a result, even in the case in which the relatively large speakers 50L, 50R are provided, the electronic keyboard instrument 1 can be realized which can realize a reduction in thickness of the case 20.

Additionally, with the electronic keyboard instrument 1 of the embodiment, the first control section 31 and the second control section 32 are provided in such a manner as to overlap with the first circuit board 41 and the second circuit board 42, respectively, along the sound emitting direction. According to this configuration, compared with the conventional configuration, the control components such as the first control section 31 and the second control section 32 can easily be disposed in the vicinity of the corner portions of the upper surface 20a of the case 20, thereby making it possible to increase the degree of freedom in disposing the units which are provided in the upper surface 20a of the case 20.

Further, with the electronic keyboard instrument 1 of the embodiment, the gaps G defined between the sound emitting ports 52L1, 52R1 and the first circuit board 41 and the second circuit board 42 are provided in such a manner as to overlap with the openings 20c1,20f1, 20f2, 20d1 in the direction substantially orthogonal to the sound emitting direction of the speakers 50L, 50R. According to this configuration, sounds emitted from the speakers 50L, 50R and reaching the first circuit board 41 and the second circuit board 42 are bent substantially at right angles, so that the sounds so bent are easily emitted from the openings 20c1, 20f1, 20f2, 20d1 to the outside of the case 20. In addition, sounds emitted from the speakers 50L, 50R are bent substantially at right angles only once. Thus, compared with a case in which sounds emitted from the speakers 50L, 50R are bent multiple times, the loss of sound is reduced, so that sounds emitted from the speakers 50L, 50R can be emitted to the outside of the case 20 with good efficiency. As a result, the reduction in the acoustic properties of sounds emitted through the openings 20c1, 20f1, 20f2, 20d1 can be suppressed.

Additionally, with the electronic keyboard instrument 1 of the embodiment, when the thickness direction of the case 20 is referred to as the up-down direction of the case 20, the sound emitting direction of the speakers 50L, 50R coincides with the upward direction. According to this configuration, the electronic keyboard instrument 1 can be realized which enables the first control section and the second control section to be disposed in the upper surface of the case 20 while realizing a reduction in size of the case 20.

With the electronic keyboard instrument 1 of the embodiment, when the thickness direction of the case 20 is referred to as the up-down direction of the case 20, the openings 20c1, 20f1, 20f2, 20d1 are provided in such a manner as to open in at least one of the left-right direction and the front-rear direction of the case 20. According to this configuration, in such a case that the sound emitting direction of the speakers 50L, 50R is upward, the openings 20c1, 20f1, 20f2, 20d1 can be provided in such a manner as to open in the direction substantially orthogonal to the sound emitting direction of the speakers 50L, 50R. As a result, sounds emitted from the speakers 50L, 50R can effectively be emitted from the openings 20c1, 20f1, 20f2, 20d1 to the outside of the case 20.

With the electronic keyboard instrument 1 of the embodiment, when the thickness direction of the case 20 is referred to as the up-down direction of the case 20, the case 20 includes the upper case 22 and the lower case 24 which are provided in such a manner as to sandwich the speakers 50L, 50R therebetween in the up-down direction. This can provide a specific configuration for arrangement of the speakers 50L, 50R which enables the first control section 31 and the second control section 32 to be disposed in the sound emitting direction of the speakers 50L, 50R while realizing a reduction in size of the case 20.

In addition, with the electronic keyboard instruments 101, 201 according to the first modified example and the second modified example of the embodiment, the openings 120c1, 120f1, 120f2, 220c1, 220f1, 220f2 each include the multiple slit-like openings or the multiple substantially circular openings. According to this configuration, when compared with, for example, a case in which each opening includes one substantially horizontally elongated rectangular opening, the respective opening areas of the openings 120c1, 120f1, 120f2, 220c1, 220f1, 220f2 become small, thereby making it possible to maintain the sound emitting effect while maintaining the strength of the case 20. In other words, a good balance can be realized between the acoustic effect of sounds emitted from the openings 120c1, 120f1, 120f2, 220c1, 220f1, 220f2 and the strength of the case 20.

Additionally, the electronic keyboard instruments 1, 101, 201 according to the embodiment and the first and second modified examples thereof include the afore-said speakers 50L, 50R and the keyboard 10 which is provided in the position where the keyboard 10 does not overlap with the speakers 50L, 50R, as well as the first circuit board 41 and the second circuit board 42 in the sound emitting direction. According to this configuration, the electronic keyboard instruments 1, 101, 201 can be realized in which the first control section 31 and the second control section 32 are provided in the sound emitting direction, and in the positions where the first and second control sections 31, 32 do not overlap with the keyboard 10, while realizing a reduction in size of the case 20.

Here, the embodiment that has been described heretofore is presented as the example, and hence, there is no intention of limiting the scope of the present invention by the embodiment. The novel embodiment can be carried out in other various forms, and various omissions, replacements, and modifications can be made thereto without departing from the spirit and scope of the present invention. Those resulting embodiments and modified examples of the present invention are included in the scope and gist of the present invention and are also included in the scope of inventions claimed for patent under claims below and their equivalents. For example, in the embodiment described above, the individual openings are described as opening in the directions (the front-rear direction and the left-right direction) orthogonal to the sound emitting direction of the speakers. However, the invention is not limited thereto, and hence, the openings may be configured so as to open in a direction inclined slightly obliquely with respect to the orthogonal direction (obliquely sideways).

WHAT IS CLAIMED IS:

1. A sound emitting apparatus comprising:
a housing;
a sound emitting component provided in the housing and comprising a sound emitting port;
a circuit board provided in the housing in a sound emitting direction of the sound emitting component, the circuit board being disposed so as to face the sound emitting port and to be spaced apart from the sound emitting port; and
a control component provided on an upper side of the circuit board,
wherein the control component is provided in such a manner that at least a part thereof overlaps with the sound emitting component along the sound emitting direction, and
wherein the housing is provided with an opening that opens in a direction substantially orthogonal to the sound emitting direction.

2. The sound emitting apparatus according to claim 1,
wherein the control component is provided in such a manner as to overlap with the circuit board along the sound emitting direction.

3. The sound emitting apparatus according to claim 1,
wherein a gap defined between the sound emitting port and the circuit board is provided in such a manner as to overlap with the opening in the direction substantially orthogonal to the sound emitting direction.

4. The sound emitting apparatus according to claim 1,
wherein when a thickness direction of the housing is referred to as an up-down direction of the housing, the sound emitting direction coincides with an upward direction of the up-down direction.

5. The sound emitting apparatus according to claim 1,
wherein when a thickness direction of the housing is referred to as an up-down direction of the housing, the opening is provided in at least one of a left-right direction and a front-rear direction of the housing.

6. The sound emitting apparatus according to claim 5,
wherein the opening is configured such that a sound emitted from the sound emitting port of the sound emitting component strikes the circuit board and is then bent substantially at right angles to be emitted from the opening to an outside of the housing.

7. The sound emitting apparatus according to claim 6, further comprising:
a sound emitting path configured to guide a sound, which is emitted from the sound emitting port of the sound emitting component and strikes the circuit board, toward an outside of the housing in a direction substantially orthogonal to the sound emitting direction.

8. The sound emitting apparatus according to claim 1,
wherein when a thickness direction of the housing is referred to as an up-down direction, the housing comprises an upper case and a lower case configured to sandwich the sound emitting component in the up-down direction.

9. The sound emitting apparatus according to claim 1,
wherein the opening comprises multiple slit-like openings or multiple substantially circular openings.

10. An electronic keyboard instrument comprising:
the sound emitting apparatus according to claim 1; and
a keyboard provided in a position that does not overlap with the sound emitting component and the circuit board in the sound emitting direction.
